(19) United States
(12) Patent Application Publication
(10) Pub. No.: US 2021/0192642 A1
(43) Pub. Date: Jun. 24, 2021

(54) POWER CHARGE/DISCHARGE CONTROL METHOD AND APPARATUS FOR CONTROLLING ENERGY STORAGE APPARATUS BY USING SHORT-TERM POWER CONSUMPTION AMOUNT

(71) Applicant: Electronics and Telecommunications Research Institute, Daejeon (KR)

(72) Inventor: cheol-ho SHIN, Daejeon (KR)

(73) Assignee: Electronics and Telecommunications Research Institute, Daejeon (KR)

(21) Appl. No.: 17/127,253

(22) Filed: Dec. 18, 2020

(30) Foreign Application Priority Data
Dec. 20, 2019 (KR) 10-2019-0172367

(51) Int. Cl. G06Q 50/06; H02J 7/00; G05B 19/042

(52) U.S. Cl. CPC G06Q 50/06; G05B 2219/2639; G05B 19/042; H02J 7/00712

(57) ABSTRACT

A power charge/discharge control method and apparatus for controlling an energy storage apparatus by using a short-term power consumption amount are disclosed. In order to prevent use of power exceeding a peak load of power energy or reverse transmission of power to a power network due to operation of the energy storage apparatus, the power charge/discharge control apparatus predicts a short-term consumption amount in consideration of a power consumption pattern of a building, and controls charging and discharging of the energy storage apparatus in real time by using the predicted short-term power consumption amount.

### CROSS-REFERENCE TO RELATED APPLICATION(S)

This application claims the benefit of Korean Patent Application No. 10-2019-0172367, filed on Dec. 20, 2019, in the Korean Intellectual Property Office, the disclosure of which is incorporated herein by reference.

### BACKGROUND

### 1. Field of the Invention

Example embodiments relate to a power charge/discharge control method and apparatus for controlling an energy storage apparatus by using a short-term power consumption amount, and more specifically, to a method and apparatus related to a technology for controlling charging and discharging of power of an energy storage apparatus so as to manage a maximum peak load of power energy.

### 2. Description of the Related Art

An energy storage system (ESS), which is a system that stores and manages energy so as to efficiently use energy, is used for buildings such as power plants, transmission and distribution facilities, homes, factories, companies, and the like. The ESS is managed by using various methods so as to enhance the efficiency of using renewable energy. Recently, as a demand management method using the ESS, a scheduling ESS control method has been mainly used to reduce a maximum peak load by charging power energy during a light load time and discharging the power energy during a maximum load time in consideration of time-of-use rates.

However, in the scheduling ESS control method, when performing charging and discharging according to a power consumption pattern of a building to which the method is applied, the use of power exceeds the maximum peak load or reverse transmission of power occurs. In other words, in the scheduling ESS control method, when performing charging, there is a possibility of exceeding the allowed maximum peak load, and when discharging is performed excessively, there is a possibility of reverse transmission of power to a system network occurring. Therefore, it is required to analyze a building power consumption pattern first.

Accordingly, in order to widely distribute demand management using the ESS in the future, a method for automatically controlling the ESS in real time is required. Here, the ESS may automatically analyze power consumption patterns by numerous buildings or sites distributed in a city, and may reduce a peak load and energy consumption rates through the analyzed power consumption patterns. In addition, in order to automatically control ESS in real time, it is required to control the ESS based on future energy consumption prediction information since the control of the ESS is performed to cope with future energy demand.

In order to control the ESS even in consideration of the stability of a system power network in this way, a short-term future energy consumption prediction value after delta t is required. Up to date, various methods for predicting future energy consumption have been studied, from statistical techniques to recent methods using AI, and most of these future energy consumption prediction techniques are evaluating the accuracy of prediction models based on average errors.

However, most of the future energy consumption prediction techniques are based on the average errors, and thus when charge/discharge control is performed on of an energy storage apparatus in real time, there is a very high probability that a predicted energy consumption value after delta t is greater or less than an actual energy consumption amount after delta t. A problem related to prediction accuracy due to the average errors may occur frequently, and thus a method for predicting a short-term power consumption amount after delta t is required to solve the problem.

### SUMMARY

Aspects provide an apparatus and method for predicting power consumption amount after delta (Δ)-t required for real-time operation of an energy storage system (ESS) in consideration of a power consumption pattern and controlling an amount of charge and an amount of discharge after delta t of an energy storage apparatus in real time by using the predicted power consumption amount after delta t so that power exceeding a peak load permissible limit is not used from a system power network, or conversely, reverse transmission of power from a load to the system power network does not occur, so as to perform charging and discharging of power of the energy storage apparatus.

According to an aspect, there is provided a power charge/discharge control method including setting an energy monitoring period from a current time point to a past time point in consideration of a purpose of predicting a power consumption amount, setting energy consumption amount fluctuation points per delta t based on a building energy consumption amount in the energy monitoring period, determining a short-term power consumption amount after delta t by using a peak point of the energy consumption amount fluctuation points per delta t, and controlling an amount of charge after delta t and an amount of discharge after delta t of an energy storage apparatus by using the short-term power consumption amount after delta t.

The determining may include, when controlling the amount of charge after delta t of the energy storage apparatus, determining a peak point having a maximum value among the energy consumption amount fluctuation points per delta t as the short-term power consumption amount after delta t.

The short-term power consumption amount after delta t may have an increase value greater than the building energy consumption amount.

The controlling may include controlling the amount of charge after delta t of the energy storage apparatus in consideration of a charging time of the energy storage apparatus within a light load time so that a system power consumption amount does not exceed a peak load permissible limit.

The determining may include, when controlling the amount of discharge after delta t of the energy storage apparatus, determining a peak point having a minimum value among the energy consumption amount fluctuation points per delta t as the short-term power consumption amount after delta t.

The short-term power consumption amount after delta t may have a reduction value less than the building energy consumption amount.

The controlling may include controlling the amount of discharge after delta t of the energy storage apparatus in consideration of a discharging time of the energy storage apparatus within a maximum load time so as to prevent reverse transmission of power to a system power network due to a load.

According to another aspect, there is provided a power charge/discharge control method including determining an actual energy consumption amount and a predicted energy consumption amount at delta t, determining an absolute error ratio at delta t by using the actual energy consumption amount and the predicted energy consumption amount, determining a short-term power consumption amount after delta t by using maximum values of the absolute error ratio at delta t, and controlling an amount of charge after delta t and an amount of discharge after delta t of an energy storage apparatus by using the maximum values and the short-term power consumption amount after delta t.

The controlling may include controlling the amount of charge after delta t and the amount of discharge after delta t by calculating the short-term power consumption amount after delta t and the maximum values in consideration of a peak load permissible limit or whether power is transmitted in reverse.

According to a still another aspect, there is provided a power charge/discharge control apparatus including a processor. The processor may be configured to set an energy monitoring period from a current time point to a past time point in consideration of a purpose of predicting a power consumption amount, set energy consumption amount fluctuation points per delta t based on a building energy consumption amount in the energy monitoring period, determine a short-term power consumption amount after delta t by using a peak point of the energy consumption amount fluctuation points per delta t, and control an amount of charge after delta t and an amount of discharge after delta t of an energy storage apparatus by using the short-term power consumption amount after delta t.

When controlling the amount of charge after delta t of the energy storage apparatus, the processor may be configured to determine a peak point having a maximum value among the energy consumption amount fluctuation points per delta t as the short-term power consumption amount after delta t.

The short-term power consumption amount after delta t may have an increase value greater than the building energy consumption amount.

The processor may be configured to control the amount of charge after delta t of the energy storage apparatus in consideration of a charging time of the energy storage apparatus within a light load time so that a system power consumption amount does not exceed a peak load permissible limit.

When controlling the amount of discharge after delta t of the energy storage apparatus, the processor may be configured to determine a peak point having a minimum value among the energy consumption amount fluctuation points per delta t as the short-term power consumption amount after delta t.

The short-term power consumption amount after delta t may have a reduction value less than the building energy consumption amount.

The processor may be configured to control the amount of discharge after delta t of the energy storage apparatus in consideration of a discharging time of the energy storage apparatus within a maximum load time so as to prevent reverse transmission of power to a system power network due to a load.

According to a still another aspect, there is provided a power charge/discharge control apparatus including a processor. The processor may be configured to determine an actual energy consumption amount and a predicted energy consumption amount at delta t, determine an absolute error ratio at delta t by using the actual energy consumption amount and the predicted energy consumption amount, determine a short-term power consumption amount after delta t by using maximum values of the absolute error ratio at delta t, and control an amount of charge after delta t and an amount of discharge after delta t of an energy storage apparatus by using the maximum values and the short-term power consumption amount after delta t.

The processor may be configured to control the amount of charge after delta t and the amount of discharge after delta t by calculating the short-term power consumption amount after delta t and the maximum values in consideration of a peak load permissible limit or whether power is transmitted in reverse.

Additional aspects of example embodiments will be set forth in part in the description which follows and, in part, will be apparent from the description, or may be learned by practice of the disclosure.

According to an example embodiment, in demand management of an energy consumption amount of a building using an energy storage apparatus, it is possible to use a possible charging time or a possible discharging time (for example, a light load time or a maximum load time of time-of-use rates) by using a short-term power consumption amount after instantaneous delta t.

According to an example embodiment, the energy storage apparatus may be controlled by automatically reflecting a power consumption pattern of the building, thereby preventing, with charging and discharging operations of the energy storage apparatus performed at a minimum, the use of power exceeding a peak load permissible limit from a system power network, or conversely, reverse transmission of power from a load to the system power network.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a process of determining an amount of charge and an amount of discharge of an energy storage apparatus according to an example embodiment;

FIG. 2A is a graph illustrating a result of predicting a short-term power consumption amount after delta t based on an amount of charge and an increase value of an energy storage apparatus according to an example embodiment;

FIG. 2B is a graph illustrating a result of predicting a short-term power consumption amount after delta t based on an amount of charge and an increase value of an energy storage apparatus according to another example embodiment;

FIG. 3 is a graph illustrating a short-term power consumption amount after delta t by using a peak point having a maximum value among energy consumption amount fluctuation points per delta t according to an example embodiment;

FIG. 4A is a graph illustrating a result of predicting a short-term power consumption amount after delta t based on an amount of discharge and a reduction value of an energy storage apparatus according to an example embodiment;

FIG. 4B is a graph illustrating a result of predicting a short-term power consumption amount after delta t based on an amount of discharge and a reduction value of an energy storage apparatus according to another example embodiment;

FIG. 5 is a graph illustrating a short-term power consumption amount after delta t by using a peak point having a minimum value among energy consumption amount fluctuation points per delta t according to an example embodiment;

FIG. 6 is a graph illustrating a prediction error ratio calculated by using a short-term energy consumption amount prediction model after delta t according to an example embodiment;

FIG. 7 is a graph for controlling charging and discharging of an energy storage apparatus by using scheduling according to an example embodiment;

FIG. 8 is a graph for controlling charging and discharging of an energy storage apparatus by using a short-term power consumption amount after delta t according to an example embodiment;

FIG. 9 is a flowchart illustrating a power charge/discharge control method according to an example embodiment; and

FIG. 10 is a flowchart illustrating a power charge/discharge control method according to another example embodiment.

### DETAILED DESCRIPTION

Hereinafter, example embodiments will be described in detail with reference to the accompanying drawings.

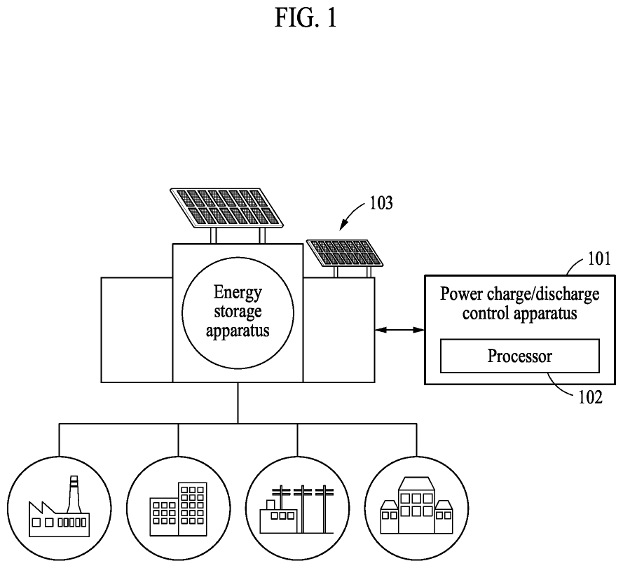

FIG. 1 is a diagram illustrating a process of determining an amount of charge and an amount of discharge of an energy storage apparatus according to an example embodiment.

Referring to FIG. 1, a power charge/discharge control apparatus 101 may control an amount of charge and an amount of discharge of the energy storage apparatus in real time. The power charge/discharge control apparatus 101 may control the amount of charge and the amount of discharge of an energy storage apparatus 103 in real time so that power exceeding a peak load permissible limit is not used from a system power network, or conversely, reverse transmission of power from a load to the system power network does not occur. The power charge/discharge control apparatus 101 may determine a short-term future, that is, a power consumption amount after delta t, so as to more accurately control the amount of charge and the amount of discharge of the energy storage apparatus 103.

Here, in controlling the energy storage apparatus, the power charge/discharge control apparatus 101 may determine the power consumption amount after delta t by separating a case of controlling the amount of charge and a case of controlling the amount of discharge from each other.

1) When controlling the amount of charge of the energy storage apparatus

When controlling the amount of charge of the energy storage apparatus, the power charge/discharge control apparatus 101 may take a charging time within a light load time based on an energy storage capacity of the energy storage apparatus into consideration. The power charge/discharge control apparatus 101 may determine the power consumption amount after delta t for controlling the amount of charge of the energy storage apparatus in real time in consideration of the charging time within the light load time. The amount of charge of the energy storage apparatus after delta t may be represented by Equation 1 below.

Amount of charge of ESS after time t<Peak load permissible limit−Short-term power consumption amount after predicted time t [Equation 1]

Referring to Equation 1, a maximum value of the amount of charge of the energy storage apparatus after delta t may be determined as “Peak load permissible limit−Short-term power consumption amount after predicted delta t”, and the power charge/discharge control apparatus 101 may control, based on the amount of charge of the energy storage apparatus after delta t, charging of the energy storage apparatus from a current time point to the current time point+delta t.

A system power consumption amount after delta t based on the charge control of the energy storage apparatus may be represented by Equation 2 below.

System power consumption amount after time-t=Amount of charge of energy storage apparatus after time-t+Actual energy consumption amount after time-t [Equation 2]

A system power consumption amount after delta t based on the charge control of the energy storage apparatus may exceed the peak load permissible limit when a short-term power consumption amount after delta t is less than an actual energy consumption amount after delta t. Conversely, the system power consumption amount after delta t based on the charge control of the energy storage apparatus may be maintained to be less than the peak load permissible limit when the short-term power consumption amount after delta t is greater than the actual energy consumption amount after delta t.

Accordingly, the power charge/discharge control apparatus 101 may control the amount of charge after delta t of the energy storage apparatus in consideration of the charging time of the energy storage apparatus within the light load time so that the system power consumption amount does not exceed the peak load permissible limit.

2) When controlling the amount of discharge of the energy storage apparatus

When controlling the amount of discharge of the energy storage apparatus, the power charge/discharge control apparatus 101 may take a discharging time within a maximum load time based on the energy storage capacity of the energy storage apparatus into consideration. The power charge/discharge control apparatus 101 may determine the power consumption amount after delta t for controlling the amount of discharge of the energy storage apparatus in real time in consideration of the discharging time within the maximum load time. The amount of discharge of the energy storage apparatus after delta t may be represented by Equation 3 below.

Amount of discharge of energy storage apparatus after time-t<Short-term power consumption amount after predicted time-t [Equation 3]

A maximum value of the amount of discharge of the energy storage apparatus after delta t for preventing reverse transmission of power to the system power network may be determined as “Short-term power consumption amount after predicted delta t”, and based on the amount of discharge of the energy storage apparatus after delta t, discharging of the energy storage apparatus may be controlled from the current time point to the current time point+delta t.

The system power consumption amount after delta t based on the discharge control of the energy storage apparatus may be represented by Equation 4 below.

System power consumption amount after time-t=Actual energy consumption amount after time-t−Amount of discharge of energy storage apparatus after time-t [Equation 4]

With respect to the system power consumption amount after delta t based on the discharge control of the energy storage apparatus, the short-term power consumption amount after delta t may be less than the actual energy consumption amount after delta t. In this case, reverse transmission of power to the system power network may not occur since the amount of discharge of the energy storage apparatus is less than the actual energy consumption amount.

With respect to the system power consumption amount after delta t based on the discharge control of the energy storage apparatus, the short-term power consumption amount after delta t may be greater than the actual energy consumption amount after delta t. In this case, reverse transmission of power to the system power network may occur since the amount of discharge of the energy storage apparatus is greater than the actual energy consumption amount.

Accordingly, the power charge/discharge control apparatus may control the amount of discharge after delta t of the energy storage apparatus in consideration of the discharging time of the energy storage apparatus within the maximum load time so as to prevent reverse transmission of power to the system power network due to a load.

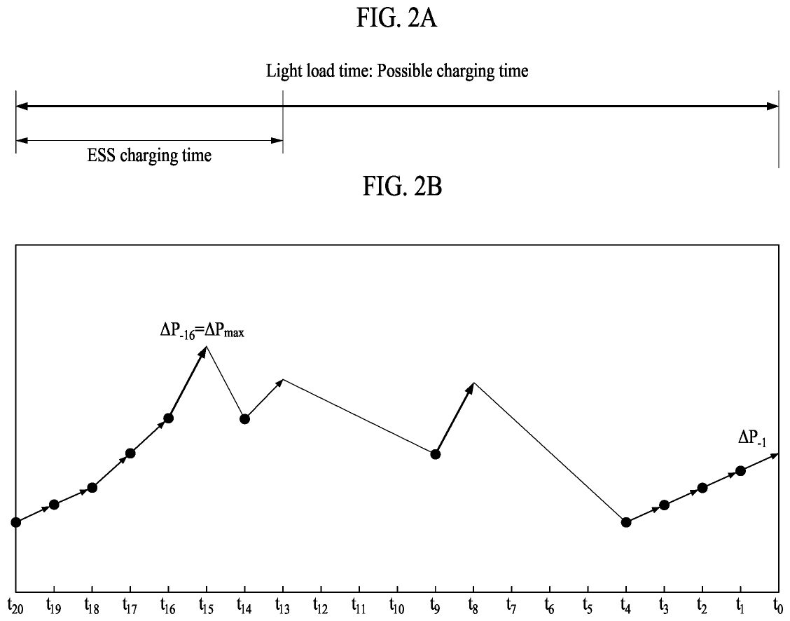

FIG. 2A and FIG. 2B is a graph illustrating a result of predicting a short-term power consumption amount after delta t based on an amount of charge and an increase value of an energy storage apparatus according to an example embodiment.

Referring to FIG. 2A and FIG. 2B, a power charge/discharge control apparatus may predict the short-term power consumption amount after delta t by using monitoring information on an energy consumption amount of a building. The power charge/discharge control apparatus may predict the short-term power consumption amount after delta t for the short-term future so as to control charging of the energy storage apparatus.

Here, the energy storage apparatus, which is a device that is generally installed and used in a building, may be charged during a light load time when a power rate is the lowest. Since charging of the energy storage apparatus needs to be performed only during the light load time as illustrated in FIG. 2A, rapid charging may not need to be performed.

A peak load permissible limit, a system power consumption amount, the energy consumption amount of the building, and the amount of charge of the energy storage apparatus for controlling charging of the energy storage apparatus may be represented by Equation 5 below.

Peak load permissible limit>System power consumption amount=Building energy consumption amount+Amount of charge of ESS [Equation 5]

Referring to Equation 5, the power charge/discharge control apparatus may determine the amount of charge of the energy storage apparatus so that a system power consumption amount after delta t does not exceed a peak load permissible limit. The power charge/discharge control apparatus may determine the short-term power consumption amount after delta t so as to determine the amount of charge of the energy storage apparatus.

In order to control the energy storage apparatus in real time as indicated in Equation 5, the power charge/discharge control apparatus may predict the short-term power consumption amount after delta t to be greater than an actual energy consumption amount of the building. When the short-term power consumption amount after delta t is predicted to be greater than the actual energy consumption amount, charging of the energy storage apparatus may be performed slowly within the light load time, and a possibility of the system power consumption amount exceeding the peak load permissible limit may be greatly reduced.

Accordingly, the power charge/discharge control apparatus may set an energy monitoring period from a current time point to a past time point in consideration of a purpose of predicting a power consumption amount. The power charge/discharge control apparatus may set energy consumption amount fluctuation points per delta t based on the building energy consumption amount in the energy monitoring period. The power charge/discharge control apparatus may determine the short-term power consumption amount after delta t by using a peak point of the energy consumption amount fluctuation points per delta t.

The power charge/discharge control apparatus may determine a peak point having a maximum value among the energy consumption amount fluctuation points per delta t as the short-term power consumption amount after delta t. In this case, the short-term power consumption amount after delta t may have an increase value greater than the building energy consumption amount as illustrated in FIG. 2B, which may be represented by Equation 6 below.

Increase value of short-term power consumption amount afterΔt=ΔPₘₐₓ=|Max[ΔP₋₍ₙ₋₁₎. . . ΔP₋₂ΔP₋₁] [Equation 6]

Here, the power charge/discharge control apparatus may set a monitoring period for selecting an increase value of the short-term power consumption amount after delta t as one day to several years according to the purpose, and may analyze weekdays and holidays separately from each other.

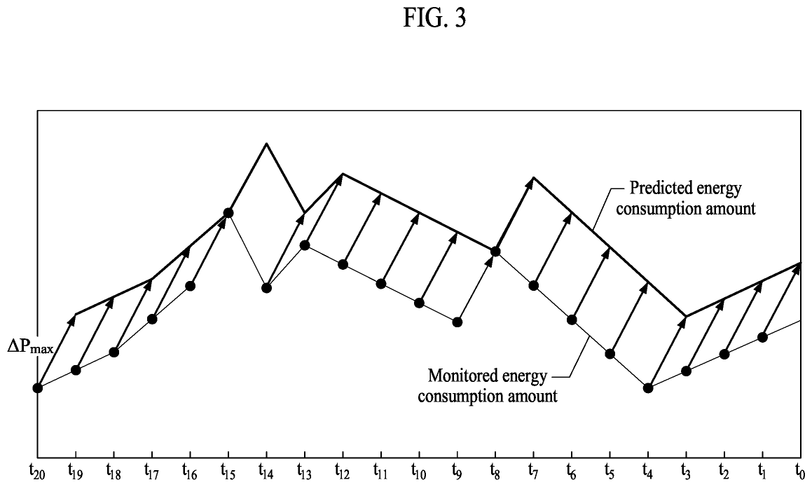

FIG. 3 is a graph illustrating a short-term power consumption amount after delta t by using a peak point having a maximum value among energy consumption amount fluctuation points per delta t according to an example embodiment.

The graph of FIG. 3 may illustrate short-term power consumption amounts to be used to control charging of an energy storage apparatus by using ΔPₘₐₓ obtained through Equation 6 of FIG. 2. According to the graph of FIG. 3, it can be seen that short-term power consumption amounts are predicted to be greater than an actual monitored energy consumption amount.

An amount of charge of the energy storage apparatus after delta t calculated by using ΔPₘₐₓ obtained through Equation 6 of FIG. 2 may be represented by Equation 7 below.

Amount of charge of ESS after Δt=Peak load permissible limit−(Current energy consumption amount+ΔPₘₐₓ) [Equation 7]

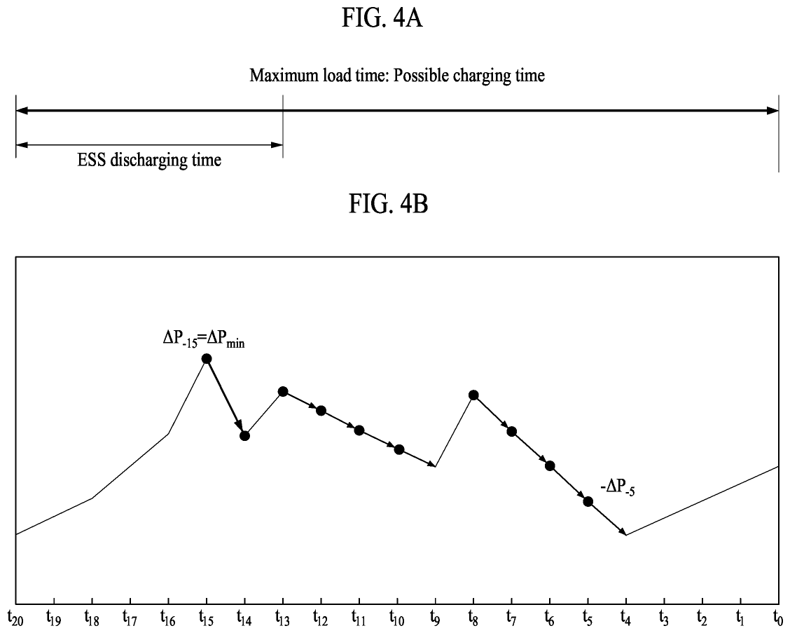

FIG. 4A and FIG. 4B is a graph illustrating a result of predicting a short-term power consumption amount after delta t based on an amount of discharge and a reduction value of an energy storage apparatus according to an example embodiment.

Referring to FIG. 4A and FIG. 4B, a power charge/discharge control apparatus may predict the short-term power consumption amount after delta t by using monitoring information on an energy consumption amount of a building. The power charge/discharge control apparatus may predict the short-term power consumption amount after delta t for the short-term future so as to control discharging of the energy storage apparatus.

Here, the energy storage apparatus, which is a device that is generally installed and used in a building, may be charged at a maximum load time when a power rate is the highest. Since discharging of the energy storage apparatus needs to be performed only during the maximum load time as illustrated in FIG. 4A, rapid charging may not need to be performed.

A system power consumption amount, the energy consumption amount of the building, and the amount of discharge of the energy storage apparatus for controlling discharging of the energy storage apparatus may be represented by Equation 8 below.

0<System power consumption amount=Building energy consumption amount+Amount of discharge of ESS [Equation 8]

Referring to Equation 8, the power charge/discharge control apparatus may determine the amount of discharge of the energy storage apparatus so that reverse transmission of power to a system power network does not occur due to excessive discharging of the energy storage apparatus after delta t. The power charge/discharge control apparatus may determine the short-term power consumption amount after delta t so as to determine the amount of discharge of the energy storage apparatus.

In order to control the energy storage apparatus in real time as indicated in Equation 8, the power charge/discharge control apparatus may predict the short-term power consumption amount after delta t to be less than an actual energy consumption amount of the building. When the short-term power consumption amount after delta t is predicted to be less than the actual energy consumption amount, discharging of the energy storage apparatus may be performed slowly, and a possibility of reverse transmission of power to a system network due to excessive discharging of the energy storage apparatus may be greatly reduced.

Accordingly, the power charge/discharge control apparatus may set an energy monitoring period from a current time point to a past time point in consideration of a purpose of predicting a power consumption amount. The power charge/discharge control apparatus may set energy consumption amount fluctuation points per delta t based on the building energy consumption amount in the energy monitoring period. The power charge/discharge control apparatus may determine the short-term power consumption amount after delta t by using a peak point of the energy consumption amount fluctuation points per delta t.

The power charge/discharge control apparatus may determine a peak point having a minimum value among the energy consumption amount fluctuation points per delta t as the short-term power consumption amount after delta t. In this case, the short-term power consumption amount after delta t may have a reduction value less than the building energy consumption amount as illustrated in FIG. 4B, which may be represented by Equation 9 below.

Reduction value of short-term power consumption amount after Δt=ΔPₘᵢₙ=Min[ΔP₋ₙΔP₋₍ₙ₋₁₎. . . ΔP₋₃ΔP₋₂ΔP₋₁]

Here, the power charge/discharge control apparatus may set a monitoring period for selecting a reduction value of the short-term power consumption amount after delta t as one day to several years according to the purpose, and may analyze weekdays and holidays separately from each other.

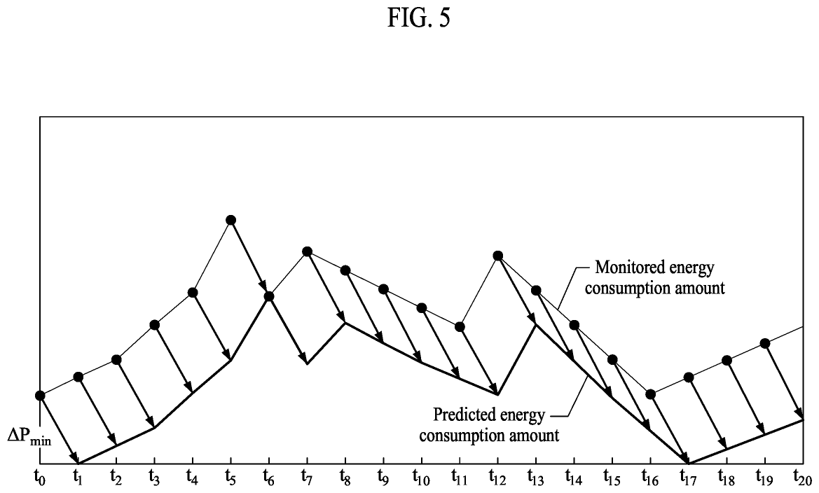

FIG. 5 is a graph illustrating a short-term power consumption amount after delta t using a peak point having a minimum value among energy consumption amount fluctuation points per delta t according to an example embodiment.

The graph of FIG. 5 may illustrate short-term power consumption amounts used to control discharging of an energy storage apparatus by using ΔPₘᵢₙ obtained through Equation 9 of FIG. 4. According to the graph of FIG. 5, it can be seen that short-term power consumption amounts are predicted to be less than an actual monitored energy consumption amount.

An amount of discharge of the energy storage apparatus after delta t calculated by using ΔPₘᵢₙ obtained through Equation 9 of FIG. 4 may be represented by Equation 10 below.

Amount of discharge of ESS after Δt=Predicted value of energy consumption amount after Δt=Current energy consumption amount+ΔPₘᵢₙ [Equation 10]

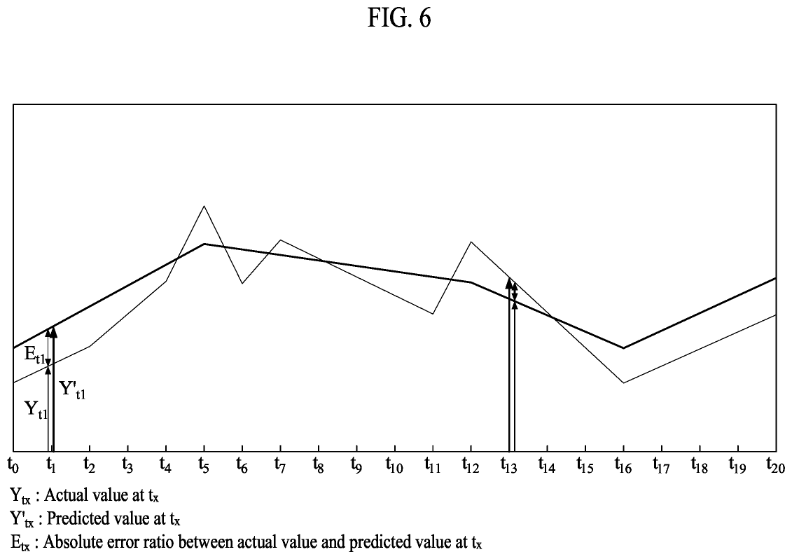

FIG. 6 is a graph illustrating a prediction error ratio calculated by using a short-term energy consumption amount prediction model after delta t according to an example embodiment.

Referring to FIG. 6, a power charge/discharge control apparatus may predict a short-term power consumption amount after delta t by using the short-term power consumption prediction model after delta t. Specifically, the power charge/discharge control apparatus may determine an actual energy consumption amount and a predicted energy consumption amount at delta t. The power charge/discharge control apparatus may determine an absolute error ratio at delta t by using the actual energy consumption amount and the predicted energy consumption amount. The power charge/discharge control apparatus may determine the short-term power consumption amount after delta t by using maximum values of the absolute error ratio at delta t. The power charge/discharge control apparatus may control an amount of charge after delta t and an amount of discharge after delta t of an energy storage apparatus by using the maximum values and the short-term power consumption amount after delta t.

Accordingly, the absolute error ratio at delta t may be represented by Equation 11 below.

$${E}_{tx} = ABS ( \frac{{Y}_{tx} - {Y}_{tx}^{′}}{{Y}_{tx}} ) \qquad [ Equation 11 ]$$

When a maximum value of Eₜₓ is defined as Eₘₐₓ with reference to Equation 11, Eₘₐₓ may be represented by Equation 12 below.

Absolute error ratio at time-t at tₓ=Eₘₐₓ=Max[Eₜ₀Eₜ₁Eₜ₂. . . Eₜ₍ₙ₋1)Eₜₙ]

An amount of charge of the energy storage apparatus after delta t may be represented by Equation 13 below by using Eₘₐₓ obtained through Equation 12 and Yₜ₁ obtained through the short-term power consumption amount after delta t obtained through the energy consumption amount prediction model.

Amount of charge of ESS after Δt=Peak load permissible limit−Yₜ₁*(1+Eₘₐₓ) [Equation 13]

The amount of discharge of the energy storage apparatus after delta t may be represented by Equation 14 below by using E. obtained through Equation 12 and Yₜ₁ obtained through the short-term power consumption amount after delta t obtained through the energy consumption amount prediction model.

Amount of discharge of ESS after Δt=Yₜ₁*(1−Eₘₐₓ) [Equation 14]

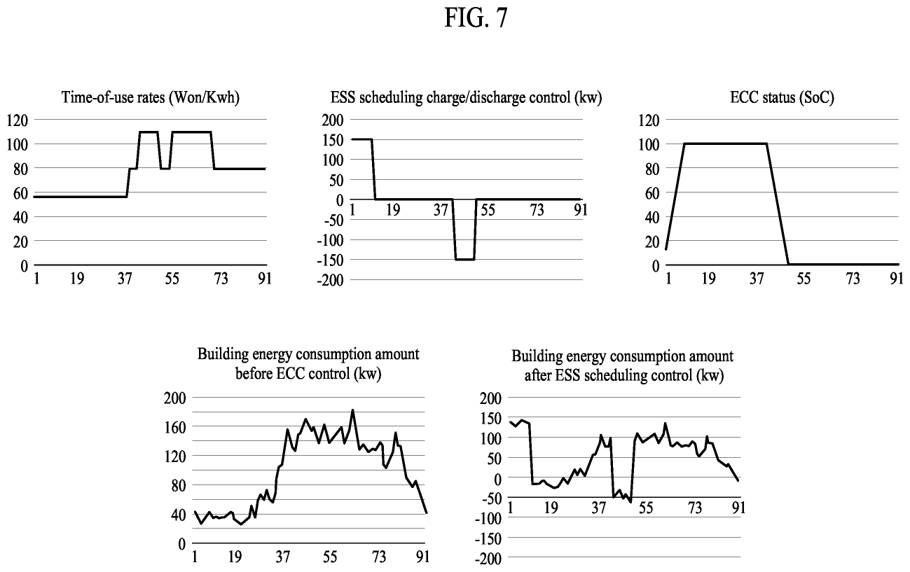

FIG. 7 is a graph for controlling charging and discharging of an energy storage apparatus by using scheduling according to an example embodiment.

A power charge/discharge control apparatus may control the energy storage apparatus by using a scheduling technique. As described above, the energy storage apparatus for demand management may perform charging during a light load time when a power rate is the lowest, and may perform discharging during a maximum load time when the power rate is the highest. In order to increase a rate of return using an operation of the energy storage apparatus, charging and discharging operations using an entire capacity of the energy storage apparatus may need to be performed per day.

To this end, the power charge/discharge control apparatus may perform charging on the energy storage apparatus for three hours during the light load time, and may perform discharging on the energy storage apparatus for three hours during the maximum load time. An operation example in which such a scheduling operation is performed may be the same as the graph of FIG. 7.

Accordingly, the graph of FIG. 7 may be a result of scheduling and controlling the energy storage apparatus in consideration of only a light load time zone and a maximum load time zone of time-of-use rates without considering an energy consumption pattern of a building before controlling the energy storage apparatus. Referring to an energy consumption amount of the building after performing scheduling control on the energy storage apparatus, it can be seen that excessive charging occurring in some time zones may result in a period exceeding a maximum load of original building energy, and excessive discharging occurring in some time zones may result in reverse transmission of power to a system network.

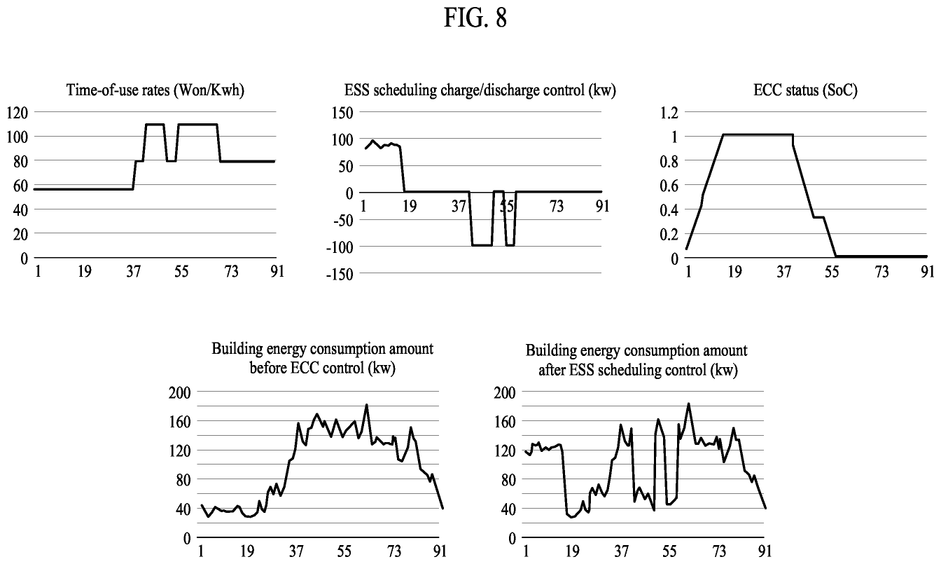

FIG. 8 is a graph for controlling charging and discharging of an energy storage apparatus by using a short-term power consumption amount after delta t according to an example embodiment.

A power charge/discharge control apparatus may control the energy storage apparatus by using the short-term power consumption amount after delta t. The power charge/discharge control apparatus may determine an amount of charge of the energy storage apparatus after delta t as indicated in Equation 7 and Equation 13 by using the short-term power consumption amount after delta t. The power charge/discharge control apparatus may determine an amount of discharge the energy storage apparatus after delta t as indicated in Equation 10 and Equation 14 by using the short-term power consumption amount after delta t. An operation example in which such a scheduling operation is performed may be the same as the graph of FIG. 8.

Accordingly, referring to a real-time charge/discharge control operation of the energy storage apparatus in the graph of FIG. 8, it can be seen that an amount of charge/discharge of the energy storage apparatus changes according to a power consumption pattern of a building, and a control time is lengthened, unlike FIG.7. In addition, it can be seen that complete discharge does not occur by controlling an amount of discharge of an ESS during last two days when a building energy consumption amount is low. In addition, after real-time control of the ESS, it can be seen that there is no period in which a building energy consumption amount exceeds an original building energy maximum load or reverse transmission of power occurs.

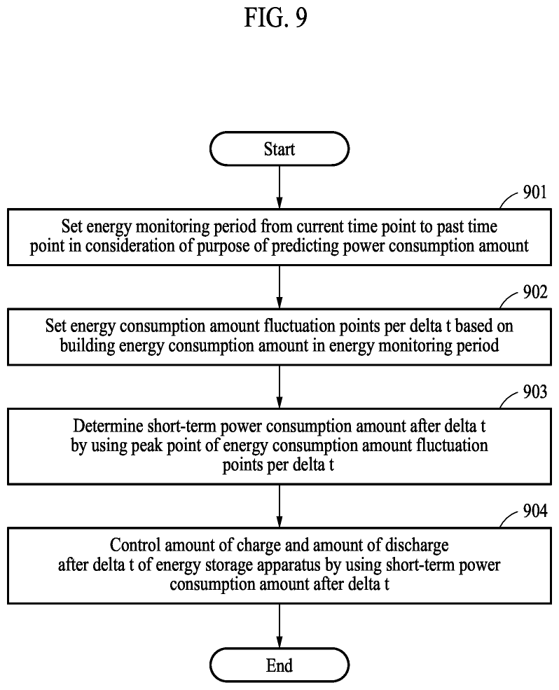

FIG. 9 is a flowchart illustrating a power charge/discharge control method according to an example embodiment.

In operation 901, a power charge/discharge control apparatus may set an energy monitoring period from a current time point to a past time point in consideration of a purpose of predicting a power consumption amount.

In operation 902, the power charge/discharge control apparatus may set energy consumption amount fluctuation points per delta t based on a building energy consumption amount in the energy monitoring period. Here, when controlling an amount of charge after delta t of an energy storage apparatus, the power charge/discharge control apparatus may determine a peak point having a maximum value among the energy consumption amount fluctuation points per delta t as a short-term power consumption amount after delta t. In this case, the short-term power consumption amount after delta t may have an increase value greater than the building energy consumption amount.

Conversely, when controlling an amount of discharge after delta t of the energy storage apparatus, the power charge/discharge control apparatus may determine a peak point having a minimum value among the energy consumption amount fluctuation points per delta t as the short-term power consumption amount after delta t. In this case, the short-term power consumption amount after delta t may have a reduction value less than the building energy consumption amount.

In operation 903, the power charge/discharge control apparatus may determine the short-term power consumption amount after delta t by using a peak point of the energy consumption amount fluctuation points per delta t.

In operation 904, the power charge/discharge control apparatus may control the amount of charge after delta t and the amount of discharge after delta t of the energy storage apparatus by using the short-term power consumption amount after delta t. Here, the power charge/discharge control apparatus may control the amount of charge after delta t of the energy storage apparatus in consideration of a charging time of the energy storage apparatus within a light load time so that a system power consumption amount does not exceed a peak load permissible limit.

Conversely, the power charge/discharge control apparatus may control the amount of discharge after delta t of the energy storage apparatus in consideration of a discharging time of the energy storage apparatus within a maximum load time so as to prevent reverse transmission of power to a system power network due to a load.

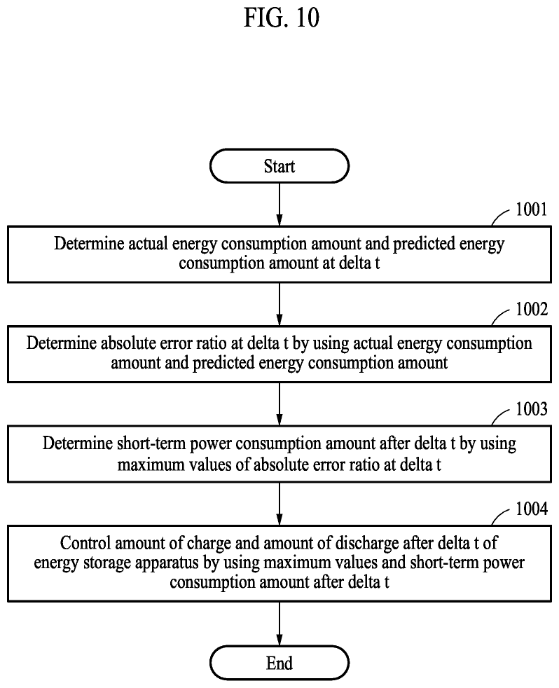

FIG. 10 is a flowchart illustrating a power charge/discharge control method according to another example embodiment.

In operation 1001, a power charge/discharge control apparatus may determine an actual energy consumption amount and a predicted energy consumption amount at delta t.

In operation 1002, the power charge/discharge control apparatus may determine an absolute error ratio at delta t by using the actual energy consumption amount and the predicted energy consumption amount.

In operation 1003, the power charge/discharge control apparatus may determine a short-term power consumption amount after delta t by using maximum values of the absolute error ratio at delta t.

In operation 1004, the power charge/discharge control apparatus may control an amount of charge after delta t and an amount of discharge after delta t of an energy storage apparatus by using the maximum values and the short-term power consumption amount after delta t. Specifically, when controlling the amount of charge of the energy storage apparatus, the power charge/discharge control apparatus may apply an addition operation and a multiplication operation to the power consumption amount and the maximum values, and control the amount of charge after delta t by using a result of application so that a system power consumption amount does not exceed a peak load permissible limit.

When controlling the amount of discharge of the energy storage apparatus, the power charge/discharge control apparatus may apply a subtraction operation and a multiplication operation to the power consumption amount and the maximum values, and control the amount of discharge after delta t by using a result of application so as to prevent reverse transmission of power to a system power network due to a load.

The method according to example embodiments may be embodied as a program that is executable by a computer and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, that is, a computer program tangibly embodied in an information carrier, for example, in a machine-readable storage device (for example, a computer-readable medium) or in a propagated signal for processing by, or to control an operation of a data processing apparatus, for example, a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. In general, a processor will receive instructions and data from a read-only memory or a random access memory or both. Elements of a computer may include at least one processor to execute instructions and one or more memory devices to store instructions and data. In general, a computer will also include or be coupled to receive data from, transfer data to, or perform both on one or more mass storage devices to store data, for example, magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), and the like, and magneto-optical media such as a floptical disk, and a read only memory (ROM), a random access memory (RAM), a flash memory, an erasable programmable ROM (EPROM), and an electrically erasable programmable ROM (EEPROM). A processor and a memory may be supplemented by, or integrated into, a special purpose logic circuit.

In addition, non-transitory computer-readable media may be any available media that may be accessed by a computer and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products.

It should be understood that example embodiments disclosed herein are merely illustrative and are not intended to limit the scope of the invention. It will be apparent to those skilled in the art that various modifications of the example embodiments may be made without departing from the spirit and scope of the claims and their equivalents.

What is claimed is:

1. A power charge/discharge control method comprising:
setting an energy monitoring period from a current time point to a past time point in consideration of a purpose of predicting a power consumption amount;
setting energy consumption amount fluctuation points per delta t based on a building energy consumption amount in the energy monitoring period;
determining a short-term power consumption amount after delta t by using a peak point of the energy consumption amount fluctuation points per delta t; and
controlling an amount of charge after delta t and an amount of discharge after delta t of an energy storage apparatus by using the short-term power consumption amount after delta t.

2. The power charge/discharge control method of claim 1, wherein the determining comprises, when controlling the amount of charge after delta t of the energy storage apparatus, determining a peak point having a maximum value among the energy consumption amount fluctuation points per delta t as the short-term power consumption amount after delta t.

3. The power charge/discharge control method of claim 2, wherein the short-term power consumption amount after delta t has an increase value greater than the building energy consumption amount.

4. The power charge/discharge control method of claim 1, wherein the controlling comprises controlling the amount of charge after delta t of the energy storage apparatus in consideration of a charging time of the energy storage apparatus within a light load time so that a system power consumption amount does not exceed a peak load permissible limit.

5. The power charge/discharge control method of claim 1, wherein the determining comprises, when controlling the amount of discharge after delta t of the energy storage apparatus, determining a peak point having a minimum value among the energy consumption amount fluctuation points per delta t as the short-term power consumption amount after delta t.

6. The power charge/discharge control method of claim 5, wherein the short-term power consumption amount after delta t has a reduction value less than the building energy consumption amount.

7. The power charge/discharge control method of claim 1, wherein the controlling comprises controlling the amount of discharge after delta t of the energy storage apparatus in consideration of a discharging time of the energy storage apparatus within a maximum load time so as to prevent reverse transmission of power to a system power network due to a load.

8. A power charge/discharge control method comprising:
determining an actual energy consumption amount and a predicted energy consumption amount at delta t;
determining an absolute error ratio at delta t by using the actual energy consumption amount and the predicted energy consumption amount;
determining a short-term power consumption amount after delta t by using maximum values of the absolute error ratio at delta t; and
controlling an amount of charge after delta t and an amount of discharge after delta t of an energy storage apparatus by using the maximum values and the short-term power consumption amount after delta t.

9. The power charge/discharge control method of claim 8, wherein the controlling comprises controlling the amount of charge after delta t and the amount of discharge after delta t by calculating the short-term power consumption amount after delta t and the maximum values in consideration of a peak load permissible limit or whether power is transmitted in reverse.

10. A power charge/discharge control apparatus, the power charge/discharge control apparatus comprising a processor, wherein the processor is configured to:
set an energy monitoring period from a current time point to a past time point in consideration of a purpose of predicting a power consumption amount;
set energy consumption amount fluctuation points per delta t based on a building energy consumption amount in the energy monitoring period;
determine a short-term power consumption amount after delta t by using a peak point of the energy consumption amount fluctuation points per delta t; and
control an amount of charge after delta t and an amount of discharge after delta t of an energy storage apparatus by using the short-term power consumption amount after delta t.

11. The power charge/discharge control apparatus of claim 10, wherein, when controlling the amount of charge after delta t of the energy storage apparatus, the processor is configured to determine a peak point having a maximum value among the energy consumption amount fluctuation points per delta t as the short-term power consumption amount after delta t.

12. The power charge/discharge control apparatus of claim 11, wherein the short-term power consumption amount after delta t has an increase value greater than the building energy consumption amount.

13. The power charge/discharge control apparatus of claim 10, wherein the processor is configured to control the amount of charge after delta t of the energy storage apparatus in consideration of a charging time of the energy storage apparatus within a light load time so that a system power consumption amount does not exceed a peak load permissible limit.

14. The power charge/discharge control apparatus of claim 10, wherein, when controlling the amount of discharge after delta t of the energy storage apparatus, the processor is configured to determine a peak point having a minimum value among the energy consumption amount fluctuation points per delta t as the short-term power consumption amount after delta t.

15. The power charge/discharge control apparatus of claim 14, wherein the short-term power consumption amount after delta t has a reduction value less than the building energy consumption amount.

16. The power charge/discharge control apparatus of claim 10, wherein the processor is configured to control the amount of discharge after delta t of the energy storage apparatus in consideration of a discharging time of the energy storage apparatus within a maximum load time so as to prevent reverse transmission of power to a system power network due to a load.
